(19) United States
(12) Patent Application Publication
(10) Pub. No.: US 2005/0134947 A1
(43) Pub. Date: Jun. 23, 2005

(54) Apparatus, method and program for editing images

(75) Inventors: Takashi Tsue, Kanagawa-ken (JP); Koichi Yamada, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/998,144

(22) Filed: Nov. 29, 2004

(30) Foreign Application Priority Data
Nov. 27, 2003 (JP) 396846/2003
Nov. 22, 2004 (JP) 337599/2004

(51) Int. Cl. G06F 15/00; H04N 1/46

(52) U.S. Cl. 358/537; 358/1.9; 358/1.18

(57) ABSTRACT

For generating photo albums on events such as weddings, the photo albums can always be generated with consistent quality. A photographer photographs the bride and groom at a wedding. Images are read from a developed film and stored in a file server. A photo album editing operation such as selection of the images to be included in the album is carried out with reference to an editing screen including a catalog display field having image data sets representing the images and a template display field displaying a template. Sample images having composition of images to be inserted in image insertion areas in the template in the template display field are inserted as guide images in the image insertion areas. Therefore, an operator can easily select the images to be inserted in the image insertion areas by referring to the guide images.

### BACKGROUND OF THE INVENTION

1. Field of the Invention

The present invention relates to an image editing apparatus and an image editing method for selecting an image to be inserted in an image insertion area in a template, and to a program for causing a computer to execute the image editing method.

2. Description of the Related Art

As has been described in Japanese Unexamined Patent Publication No. 9(1997)-214868, a method has been proposed for generating a photo album by reading images from a film with a film scanner and by printing an image including a selected part of the images arranged in desired layout.

In addition, another method has also been proposed in Japanese Unexamined Patent Publication No. 2003-182260 for generating a photo album by printing desired images as photographs and by inserting the photographs in photo mounting corners formed on photo album paper according to the size of the photographs and the layout of the photo album.

Meanwhile, in order to generate a photo album of a wedding, a professional photographer sometimes photographs the bride and groom as well as attendants in front of a church as a venue for the wedding or in front of a monument during the wedding. Images obtained in this manner are used for generating a photo album, and the photo album tells a story that can be enjoyed later, since the album traces the behavior of the bride and groom on their wedding day.

In order to generate a photo album, a professional photographer or an operator at a DPE store that provides a photo album generation service (hereinafter collectively referred to as an operator) stores images obtained by photography in an image server, and displays on display means such as a monitor of a workstation a catalog of the images stored in the image server and a template having an image insertion area used for photo album generation. The operator then selects one of the images to be inserted in the image insertion area from the catalog. At this time, the operator carries out image editing processing, such as processing for changing image quality (blurring or sharpness enhancement, for example), processing for re-shaping the image (such as rotation, resizing, and trimming), and processing for restoring the image (such as red-eye correction and scar removal) on the selected image so that the image inserted in the image insertion area will be attractive.

A photo album is generated by printing images edited in the above manner and pasting the images on photo album paper. A photo album can also be generated by printing composite images having a layout of the photo album, generated from edited images inserted in image insertion areas of a template, as has been described in Japanese Unexamined Patent Publication No. 9(1997)-214868.

However, the operation of editing images largely depends on the skill of an operator, and the criterion for selection of images used for a photo album, and the degree of resizing and trimming vary from an operator to operator. Therefore, a photo album generated by a skilled operator looks substantially attractive while a photo album generated by an operator not having sufficient skills does not look attractive, although the charge for photo album generation may be the same for both cases. In addition, how well photo albums are generated may be different from day to day even if the same operator generates the photo albums.

### SUMMARY OF THE INVENTION

The present invention has been conceived based on consideration of the above circumstances. An object of the present invention is therefore to generate photo albums on events such as weddings having a consistent quality.

An image editing apparatus of the present invention comprises:
display means for displaying various kinds of information;
image display control means for displaying a catalog of images on the display means;
template display control means for displaying on the display means a template used as photo album paper and having at least one image insertion area, together with the catalog of the images;
guide image display control means for displaying on the display means a guide image or guide images for guiding an image or images to be inserted correspondingly in the image insertion area or areas; and
image selection means for receiving selection of the image or images to be inserted in the corresponding image insertion area or areas from the catalog of the images.

The guide image or images refer to an image or images that notify an operator who carries out image editing of what composition the image or images should have to be inserted in the corresponding image insertion area or areas. In the case of photography for generating photo albums on events, the photography is carried out at the same place and in the same situation regardless of who a requester is. For example, in the case of photography of brides and grooms in marriage ceremonies, photography is carried out at a predetermined place such as a hotel, a church or a studio and in a predetermined situation such as exchange of marriage rings and cutting a wedding cake in reception banquets in many cases. Therefore, by using the same composition for the image or images to be inserted in image insertion area or areas in the template for all users who selected the template, a quality of a photo album generated in the above manner can be constant. Consequently, the guide image or images can be an illustration or illustrations representing the composition of the image or images to be inserted in the corresponding image insertion area or areas, a drawing or drawings, or a sample image or sample images obtained by photography of a model in an actual place or in an actual situation, for example.

Further, a past image, which was actually inserted in each of the image insertion areas of the template, may be stored, and the stored image may be used as the guide image. Further, a past image, which was obtained at the same photography place as or a similar photography place to the obtainment place of an image, which will be inserted in each of the image insertion areas, and which was selected to be actually inserted in each of the image insertion areas of the template may be stored, and the stored image may be used as the guide image. It is preferable that an image (hereinafter called a previous image), which was used in the album edit operation immediately before the present operation, is used as the past image among the past images, which have been selected to be inserted in the image insertion area of the template.

Here, the similar photography place refers to a photographing place, which is a different photography place, but which may be regarded as the same photography place because structures or the like in the background at the place are similar.

In the image editing apparatus of the present invention, the guide image display control means may display the guide image or images in the corresponding image insertion area or areas in the template displayed on the display means.

Further, the guide image may be displayed separately from each of the image insertion areas. In this case, if there is a plurality of past images as described above for a single insertion area, the plurality of past images may be displayed as the guide images separately from the image insertion area. An operator may select a single desired guide image from the plurality of past images, and the single guide image selected by the operator may be displayed in the image insertion area. Since the past image, which was actually used, is inserted in the image insertion area, the operator can easily check whether the photo album is produced successfully.

An image editing method of the present invention comprises the steps of:
displaying a catalog of images on display means;
displaying on the display means a template used as photo album paper and having at least one image insertion area, together with the catalog of the images;
displaying on the display means a guide image or guide images for guiding an image or images to be inserted correspondingly in the image insertion area or areas; and
receiving selection of the image or images to be inserted in the image insertion area or areas from the catalog of the images.

The image editing method of the present invention may be provided as a program for causing a computer to execute the image editing method.

According to the present invention, the catalog and the template are displayed on the display means together with the guide image or images for guiding the image or images to be inserted in the image insertion area or areas. Therefore, the operator can easily select the image or images having the composition to be inserted in the image insertion area or areas from the catalog, simply by viewing the display means. Consequently, the composition of the image or images to be selected does not change depending on operators or depending on days. In this manner, the photo album can be generated having a consistent quality.

Furthermore, by displaying the guide image or images in the image insertion area or areas in the template, the operator can easily confirm what composition the image or images need to have for insertion in the image insertion area or areas, by simply viewing the template. Therefore, the operator can easily select the image or images having the composition to be inserted in the image insertion area or areas from the catalog.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is alos within the scope of this invention. Additionally, computer instructions include, but are not limited to: source, object, and executable code, and can be in any language, including higher level languages, assembly language, and machine language.

### BRIEF DESCRIPTION OF THE DRAWINGS

FIG. 1 is a block diagram showing the configuration of an image editing system comprising an image editing apparatus of an embodiment of the present invention;

FIG. 2 is a block diagram showing the configuration of a photo album editing PC;

FIG. 3 shows an example of an editing screen;

FIG. 4 shows an example of guide image information;

FIG. 5 shows an example of layout information;

FIG. 6 is a flow chart showing a procedure carried out in a first embodiment;

FIG. 7 shows another example of the editing screen;

FIG. 8 is a flow chart illustrating processing performed in a second embodiment of the present invention;

FIG. 9 is a diagram illustrating a database used in the second embodiment;

FIG. 10 is a diagram illustrating an example of an editing screen in the second embodiment;

FIG. 11 is a diagram illustrating a database used in the third embodiment;

FIG. 12 is a flow chart illustrating processing performed in the third embodiment of the present invention;

FIG. 13 is a diagram illustrating an example (No. 1) of an editing screen in the third embodiment; and

FIG. 14 is a diagram illustrating an example (No. 2) of an editing screen in the third embodiment.

### DESCRIPTION OF THE PREFERRED EMBODIMENT

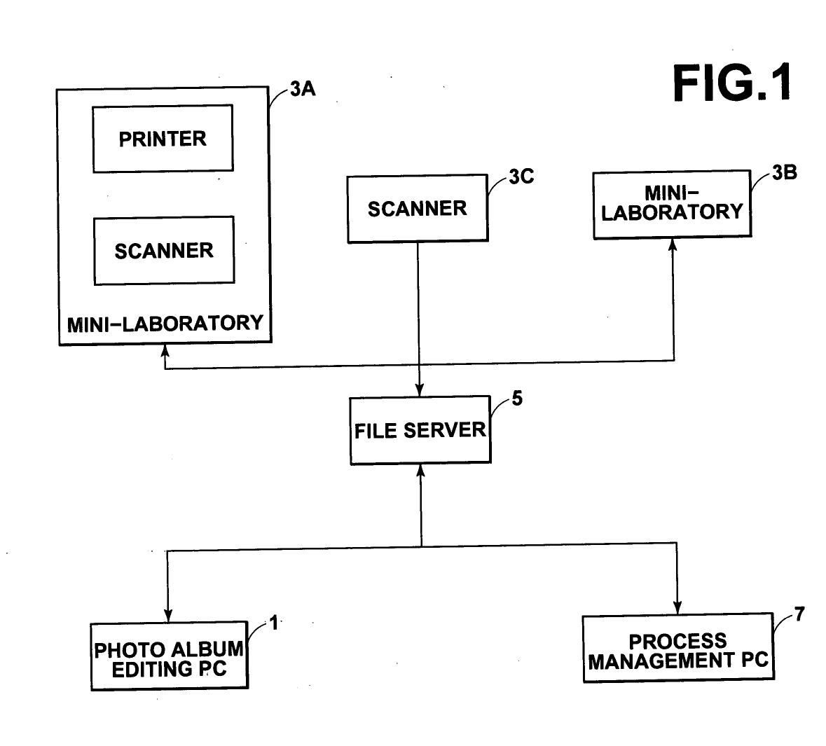

Hereinafter, an embodiment of the present invention will be described with reference to the accompanying drawings. FIG. 1 is a block diagram showing the configuration of an image editing system equipped with an image editing apparatus of a first embodiment of the present invention. As shown in FIG. 1, the image editing system in the first embodiment comprises a photo album editing personal computer (hereinafter referred to as a photo album editing PC) 1, having the function of the image editing apparatus according to the first embodiment, a plurality (2, in this case) of mini-laboratories 3A and 3B, a film scanner (hereinafter referred to as a scanner) 3C, a file server 5, and a process management PC 7 connected to each other via a network. The photo album editing PC 1 has the functions of the image editing apparatus as the embodiment of the present invention. Each of the mini-laboratories 3A and 3B has a scanner for obtaining image data sets representing images recorded on a developed film by reading the images from the film, and a printer for printing the image data sets. The file server 5 has a large-capacity hard disc for storing the image data sets. The process management PC 7 manages processes of photo album generation.

In this embodiment, the case of a wedding as an event will be described. In the wedding, a professional photographer photographs the bride and groom who requested photo album generation (hereinafter referred to as a user) on the day of wedding, and the photographer generates a photo album telling a story of the event by using the photographs. However, the event is not necessarily limited to a wedding.

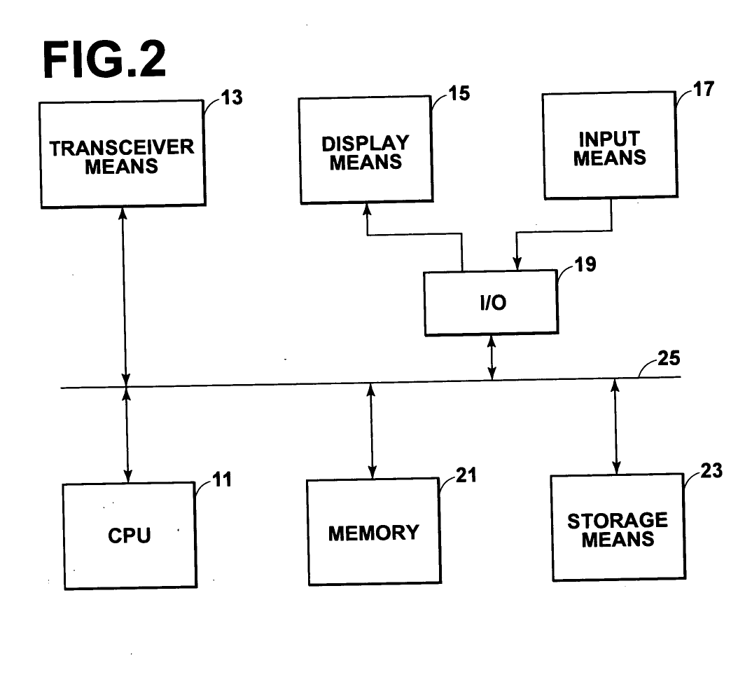

FIG. 2 is a block diagram showing the configuration of the photo album editing PC 1. As shown in FIG. 2, the photo album editing PC 1 comprises a CPU 11 (acting as the image display control means, the template display control means, and the guide image display control means), transceiver means 13 for networking, display means 15, an I/O 19, a memory 21, and storage means 23. The CPU 11 controls the photo album editing PC 1. The transceiver means 13 sends and receives the image data sets and various kinds of information to and from the file server 5. The display means 15 displays various kinds of information such as the images and a template. The I/O 19 reads various kinds of information input by an operator via input means 17 (acting as the image selection means) for delivering the information to the CPU 11. The I/O 19 also outputs a display instruction to the display means 15 according to an instruction from the CPU 11. The memory 21 comprises a ROM storing a program for operating the CPU 11 and various constants, and a RAM used by the CPU 11 as a workspace. The storage means 23 comprises a hard disc for storing various kinds of information such as the image data sets.

A bus 25 connects the CPU 11 in the photo album editing PC 1 to peripheral circuits including the transceiver means 13, the I/O 19, the memory 21, and the storage means 23. In this manner, the CPU 11 can control the peripheral circuits. More specifically, the CPU 11 controls the transceiver means 13, the display means 15, the memory 21, and the storage means 23 for reception of information such as the image data sets and a template data set, which will be described later, from the file server 5, for storing the image data sets in the storage means 23, and for displaying a catalog and the template on the display means 15 in order to select the image or images to be inserted in an image insertion area or image insertion areas (hereinafter referred to as the image insertion areas) of the template, to generate image editing information, and to transmit the image editing information to the file server 5 in response to an instruction input from the input means 17 by the operator.

The photo album editing PC 1 receives photo album editing information comprising information on the template, specified by the user who requested photo album generation and a user ID, when the operator carries out a photo album editing operation. The photo album editing PC 1 sends the photo album editing information to the file server 5 and receives the template data set, the image data sets, and guide image data sets to be inserted in the image insertion areas in the template from the file server 5. The photo album editing PC 1 then reduces the image data sets for generating the catalog of the images represented by the image data sets, and inserts guide images represented by the guide image data sets in the image insertion areas of the template represented by the template data set. In this manner, the photo album editing PC 1 displays an editing screen including the catalog and the template having the guide images inserted therein on the display means 15.

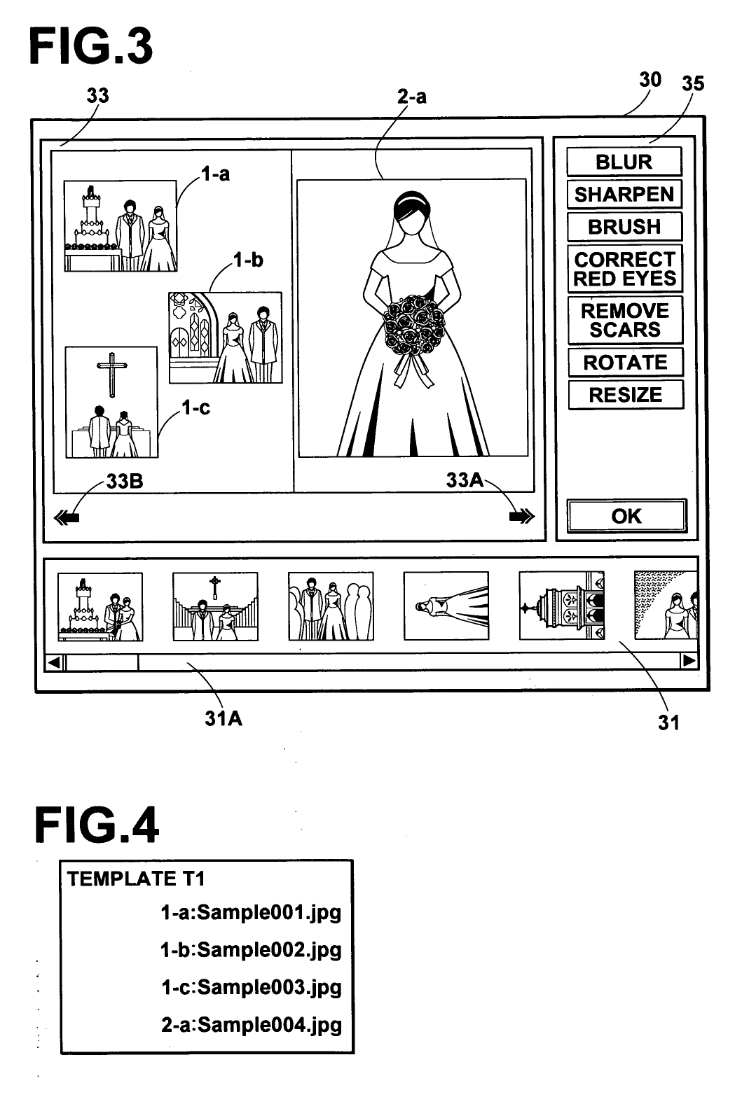

FIG. 3 shows an example of the editing screen. As shown in FIG. 3, an editing screen 30 includes a catalog display field 31 in which the catalog is displayed, a template display field 33 in which the template having the guide images inserted therein is displayed, and a tool box 35.

A scroll bar 31A is displayed in the catalog display field 31. By moving the scroll bar 31A to the right or left, a part of the images that cannot be displayed in one screen can be displayed.

In the example shown in FIG. 3, a template T1 displayed in the template display field 33 includes 4 image insertion areas named 1-a, 1-b, 1-c, and 2-a, all of which respectively have the guide images inserted therein.

The guide images notify the operator who carries out the photo album editing operation of what composition the respective images should have in the corresponding image insertion areas in the template. In the case of photography for generating photo albums on events, the photography is carried out at the same place and in the same situation regardless of who a user as a requester is. For example, in the case of photography of brides and grooms in weddings, photography is carried out at a predetermined place such as a hotel, a church, or a studio and in a predetermined situation such as exchange of marriage rings and cutting a wedding cake in many cases.

Therefore, by using the same composition for the images to be inserted in the image insertion areas in the template for all users that selected the same template, the quality of photo albums generated in the above manner can be consistent. Consequently, the guide images can be illustrations representing the composition to be inserted in the image insertion areas, drawings, or sample images obtained by photography of a model in an actual place or in an actual situation, for example. Further, a past image, which was selected to be actually inserted in an image insertion area of the temple, specified by the user, may be stored in the file server 5, and the stored image may be used as the guide image. In this embodiment, sample images generated by photographing a model are inserted in the image insertion areas 1-a, 1-b, 1-c, and 2-a.

In a header of the template data set is recorded guide image information relating the image insertion areas 1-a, 1-b, 1-c, and 2-a in the template T1 represented by the template data set to file names of the guide image data sets (sample001.jpg, sample002.jpg, sample003.jpg, and sample004.jpg) to be inserted in the respective image insertion areas, as shown in FIG. 4. The photo album editing PC1 inserts the guide image data sets in the image insertion areas of the template by referring to the guide image information recorded in the header of the template image data set.

In the template display field 33 are displayed arrow buttons 33A and 33B for changing a page of the template being displayed in the template display field 33 in the case where the template has a plurality of pages. The operator can change the page of the template to be displayed in the editing screen 30 by clicking the arrow button 33A or 33B.

In the tool box 35 are displayed buttons for carrying out image quality changing processing such as blurring, sharpening, and brushing, buttons for carrying out image restoration processing such as red-eye correction and scar removal, and buttons for carrying out image changing processing such as rotation and resizing, and an OK button for ending the processing.

The operator carries out the photo album editing operation by inputting photo album editing instructions while using the editing screen 30. More specifically, the operator selects one of the images having the same composition as the guide image inserted in one of the image insertion areas from the catalog, and drags and drops the selected image by using the input means 17. In this manner, the operator inserts the selected image in the corresponding image insertion area. After the insertion, the operator selects the image insertion area and edits the selected image inserted therein by clicking any one of the buttons in the tool box 35. For example, by clicking the button for rotation, the operator can rotate the image by 90 degrees in the clockwise direction. By clicking the button for resizing, the operator can change a size of the image. Furthermore, by clicking the button for blurring or sharpening or brushing, a quality of the image can be changed. By clicking the button for red-eye correction or scar removal, the image can be restored.

After selecting all the images to be inserted in the respective image insertion areas and editing all the selected images, the operator clicks the OK button to end the photo album editing operation using the template. The photo album editing PC 1 generates the image editing information including the file names of the selected images, information relating the file names of the images to be inserted in the respective image insertion areas and the corresponding image insertion areas, information on the processing to be carried out on the image data sets such as blurring, reduction or enlargement, and red-eye correction, information on an area to be trimmed in the case of trimming, and information on magnification ratio in the case of reduction or enlargement. The image editing information is sent to the file server 5.

The file server 5 stores the image data sets, obtained by reading the images recorded on the developed film by using the mini-laboratory 3A or 3B or the scanner 3C. The image data sets are stored in a folder generated for the user who requested the photo album generation. The file server 5 also stores the template data set representing the template to be used for photo album generation as well as the guide image data sets representing the guide images to be inserted in the image insertion areas.

The file server 5 refers to the photo album editing information sent from the photo album editing PC 1, and sends the template data set representing the template selected by the user, the image data sets stored in the folder corresponding to the user ID, and the guide image data sets representing the guide images to be inserted in the image insertion areas in the selected template to the photo album editing PC 1.

When the image editing information is sent from the photo album editing PC 1, the file server 5 refers to the file names of the image data sets representing the selected images included in the image editing information, and carries out preparatory processing and editing processing on the selected image data sets for generating processed image data sets. The preparatory processing includes at least one of brightness correction processing, color correction processing and gradation correction processing on the selected image data sets. The editing processing includes the processing specified by the image editing information. More specifically, the editing processing includes the processing for changing image quality such as blurring, sharpening, and brushing, the image re-shaping processing such as trimming and enlargement/reduction processing, and the image restoration processing such as red-eye correction and scar removal on the image data sets specified by the image editing information.

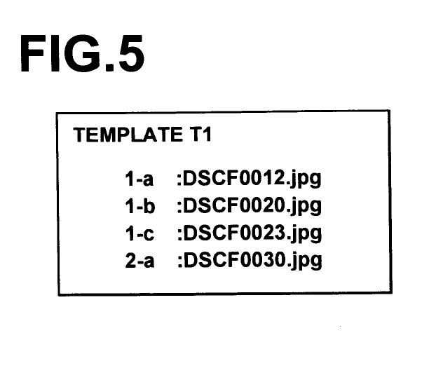

The file server 5 generates layout information from the information relating the file names of the image data sets and the image insertion areas of the template included in the image editing information. FIG. 5 shows an example of the layout information. As shown in FIG. 5, the layout information relates the names of the image data sets (DSCF0012.jpg, DSCF0020.jpg, DSCF0023.jpg, and DSCF0030.jpg) and the corresponding image insertion areas 1-a, 1-b, 1-c, and 2-a in the template T1. The file server 5 sends the processed image data sets and the layout information to either the mini-laboratory 3A or 3B.

The process management PC 7 receives information representing completion of the processes such as the photo album editing operation, printing, and photo album inspection, input by the operator, in order to manage the processes regarding each order for photo album generation. In the case where the photo album has passed the inspection carried out by the operator for examining the quality of the generated photo album, the process management PC receives information thereon and finishes the process management for the photo album. In the case where the photo album did not pass the inspection, the process management PC 7 receives an instruction for generating the photo album again.

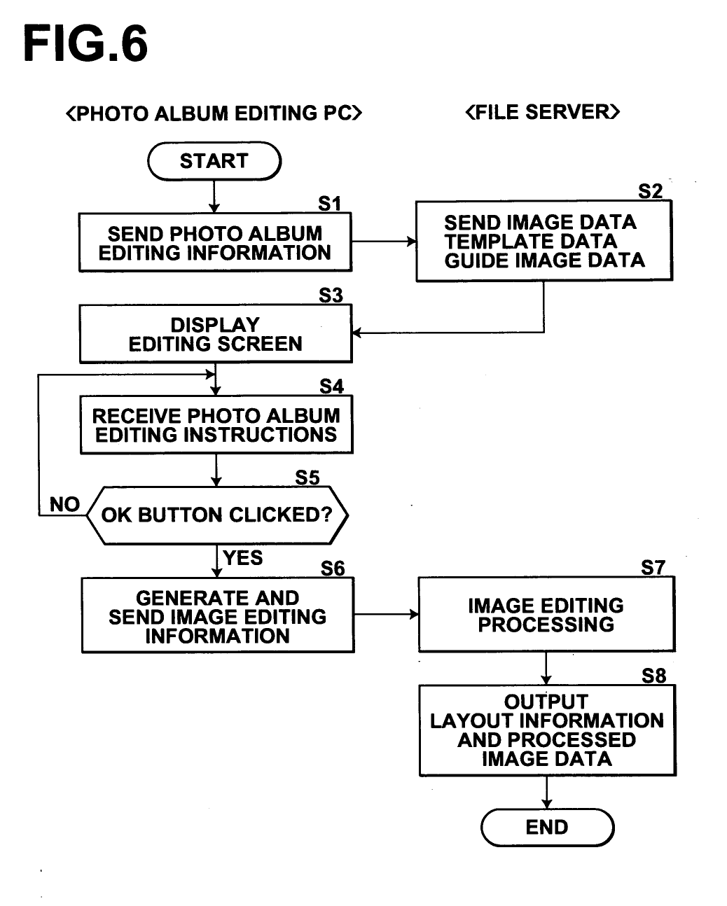

A procedure carried out in the first embodiment will be described next. FIG. 6 is a flow chart showing the procedure in the first embodiment. The file server 5 has already stored the image data sets obtained by reading the images from the developed film recorded with photographs on the wedding of the user.

When the operator inputs a photo album editing instruction from the photo album editing PC 1, the procedure starts. The photo album editing PC 1 sends the photo album editing information including the user ID and the information on the template selected by the user to the file server 5 (Step S1).

The file server 5 receives the photo album editing information, and sends the image data sets stored in the folder corresponding to the user ID, the template data set representing the template selected by the user, and the guide image data sets representing the guide images to be inserted in the image insertion areas in the template to the photo album editing PC 1 (Step S2).

The photo album editing PC 1 receives the image data sets, the template data set, and the guide image data sets, and displays the editing screen 30 on the display means 15 (Step S3). The guide images represented by the guide image data sets are inserted in the corresponding image insertion areas in the template displayed in the template display field 33 in the editing screen 30.

The photo album editing PC 1 receives the photo album editing instructions input by the operator referring to the editing screen 30 (Step S4). The photo album editing PC 1 then judges whether or not the OK button has been clicked (Step S5). If a result at Step S5 is affirmative, the photo album editing PC generates the image editing information, and sends the image editing information to the file server 5 (Step S6). If the result at Step S5 is negative, the procedure returns to Step S4 to continuously receive the editing instructions from the operator.

The file server 5 receives the image editing information, and carries out the editing processing by referring to the file names of the selected image data sets included in the image editing information (Step S7). The file server 5 sends the processed image data sets generated through the editing processing and the layout information generated from the image editing information to either the mini-laboratory 3A or 3B (Step S8) to end the procedure.

The mini-laboratory 3A or 3B receives the processed image data sets and the layout information, and prints the processed image data sets to generate prints thereof. The operator (or an operator dedicated to photo album binding) pastes the prints in print insertion areas in photo album paper corresponding to the template while referring to the layout information, and carries out binding to generate the photo album.

The operator in charge of quality control inspects the photo album generated in this manner. In the case where the photo album has passed the inspection, the photo album is sent to the user. In the case where the photo album did not pass the inspection, the process management PC 7 demands the photo album generation again.

As has been described above, in this embodiment, the guide images are displayed in the image insertion areas in the template in the template display field 33 in the editing screen 30. Therefore, the operator who carries out the editing operation can easily select the images to be inserted in the image insertion areas from the catalog by simply viewing the editing screen 30 displayed on the display means 15. Consequently, composition of the images to be selected does not change depending on operators or on days, and photo albums having the same quality can always be generated.

Furthermore, by displaying the guide images in the image insertion areas in the template, composition of the images to be inserted can be easily understood by simply viewing the template. Therefore, selection of the images to be inserted in the image insertion areas from the catalog can be carried out more easily.

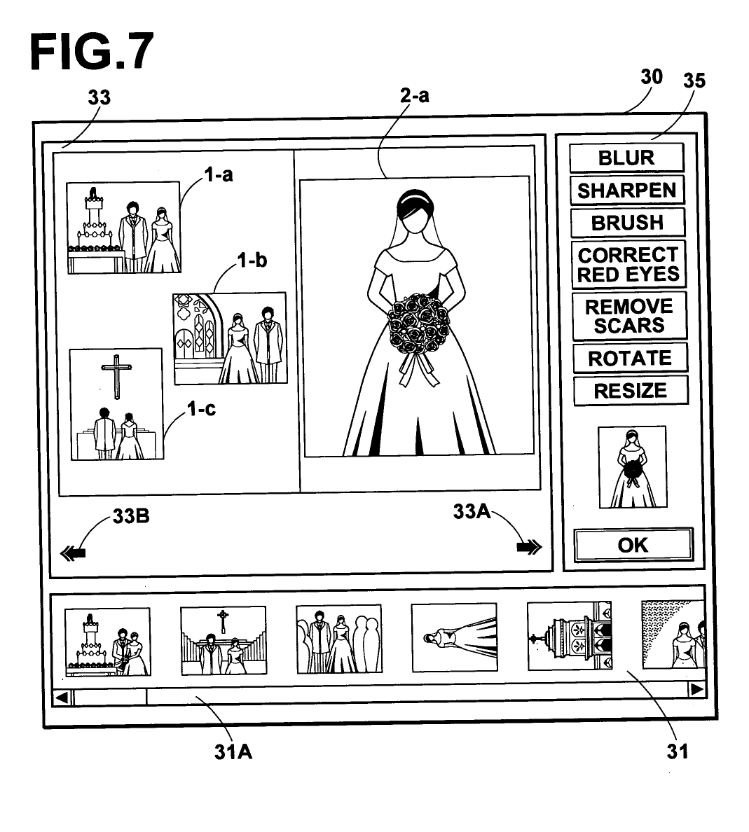

In the first embodiment described above, the guide images are inserted in the image insertion areas in the template in the editing screen 30. However, as shown in FIG. 7, one of the image insertion areas in the template may be selected by clicking the area or the like so that the guide image corresponding to the selected image insertion area can be displayed in the editing screen 30 (in the tool box 35 in the example in FIG. 7) without displaying all the guide images in the image insertion areas. In the example in FIG. 7, the image insertion area 2-a has been clicked.

Further, in the first embodiment, under the assumption that photographs of brides and grooms are taken on their wedding day at a predetermined place such as a hotel, a church or a studio and in a predetermined situation such as exchange of marriage rings and cutting a wedding cake in most of the cases, an illustration or illustrations representing the composition of the image or images to be inserted in the image insertion area or areas, a drawing or drawings, or a sample image or sample images obtained by photography of a model in an actual place or in an actual situation is used as the guide image. However, even if the same template is used, setting in the studio, the background of the bride and groom during outdoor photography, the angle during photography, or the like may differ. Further, when the season or the surrounding environment changes, the conditions of the background structures and the plants may differ. Further, a photograph plan specifying the number of photographs and photography places may be different according to the budget for producing an album and the size of the wedding. Further, when the album is actually produced, a desired image may not be obtained by the mistake in photography, or the arrangement of the images inserted in the album may be changed according to the taste of the user. Therefore, if a single guide image is prepared for a single image insertion area, the operation for producing the album may not be performed successfully in some cases.

Therefore, a file name of the image data, which has been selected to be inserted in the image insertion area, is correlated with a photography place, and stored for each template. When an album edit operation is performed by using a template, a past image, which was obtained at the same photographing place as or a similar photographing place to the obtainment place of an image, which will be inserted in the image insertion area, and which was selected to be actually inserted in the image insertion area of the same template may be stored as the guide image. Hereinafter, this is called a second embodiment of the present invention.

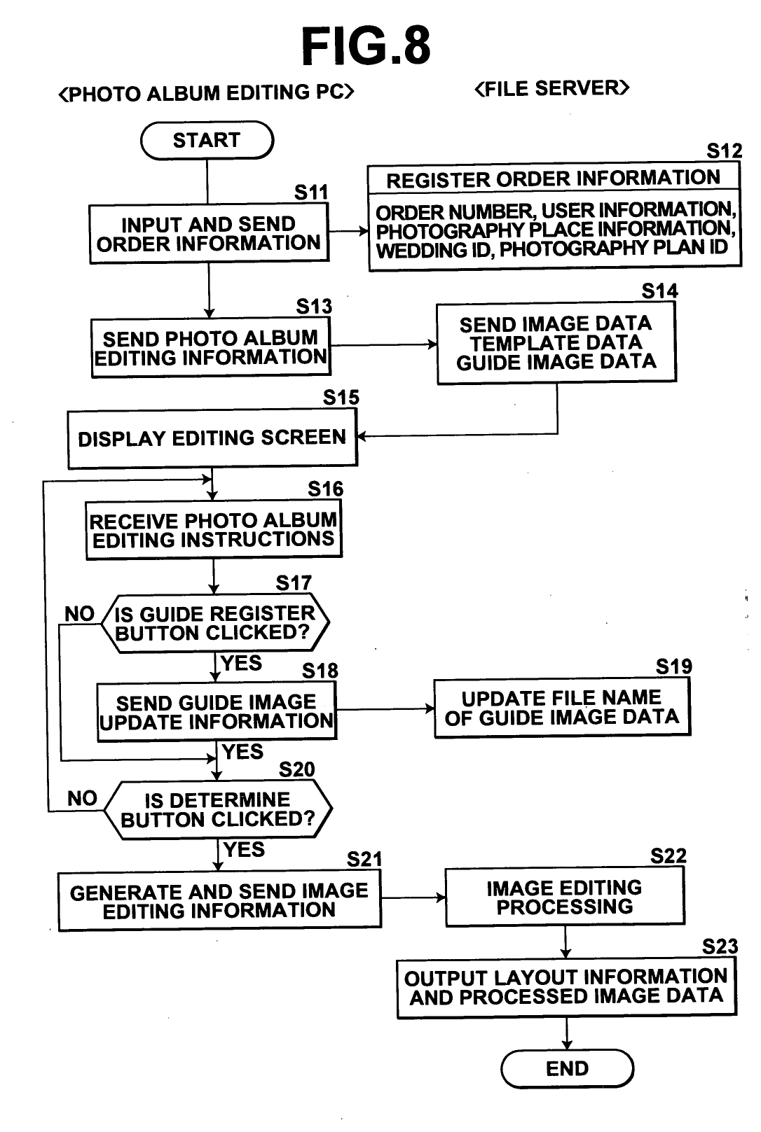

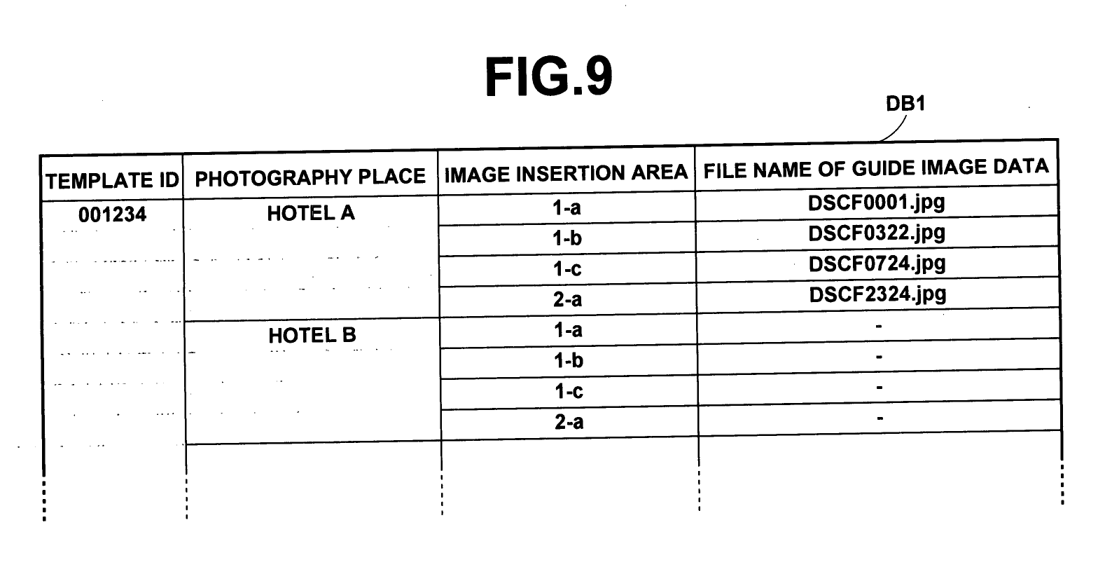

FIG. 8 is a flow chart illustrating processing performed in the second embodiment of the present invention. In the second embodiment, it is assumed that a photo album has been produced by using images, obtained by taking photographs at various photography places, and a database DB1 regarding the template to be used is stored in the file server 5. In the database DB1, information (template ID), which specifies the template, information representing the photography place of the used images, the image insertion areas, and file names of the image data (guide image data) representing the images inserted in the image insertion areas are correlated with each other as illustrated in FIG. 9. The file name of the guide image data, registered in the database DB1 is a file name of image data representing an image (hereinafter called previous images), which was selected to be actually inserted in the image insertion area of the template when an album was produced by using the template most recently.

When an operator instructs album edit at the album editing PC 1, processing starts. First, the album editing PC 1 sends order information including at least one of an order number, user information, a photographing area name, a photography place (a hotel name, a studio name, a church name, or the like), a photographing date/time, information specifying the wedding (wedding ID), and information specifying the photography plan (photography plan ID), which are input by the operator to the file server 5 (step S11). The file server 5 registers the order information (step S12). Further, the album editing PC 1 sends album edit information including information (template ID) indicating the type of the template specified by the user to the file server 5 (step S13).

The file server 5 receives the album edit information, and sends image data stored in a folder corresponding to the user ID, template data representing the type of a template, specified by the user, and guide image data, representing the guide image, which will be inserted in the image insertion area of the template, to the album editing PC 1 (step S14).

Here, in the second embodiment of the present invention, the guide image data, which is sent from the file server 5 to the album editing PC 1, is image data representing past image, which was obtained at the same photographing place as or a similar photographing place to the obtainment place of an image, which will be inserted in the image insertion area of a template in the type specified by the user, and which was selected for actually being inserted in the image insertion area of the same template. For example, if there is an order for album production by using a template with the template ID 001234, and the input photography place is hotel A, the file server 5 refers to the database DB1, and sends image data with the file names DSCF0001.jpg, DSCF0322.jpg, DSCF0724.jpg, and DSCF2324.jpg as the guide image data.

The album editing PC1 receives the image data, the template data and the guide image data, and displays the editing screen 30 on the display means 15 (step S15). The guide image represented by the guide image data is inserted in the data insertion area of the template, displayed in the template display field 33 on the editing screen 30.

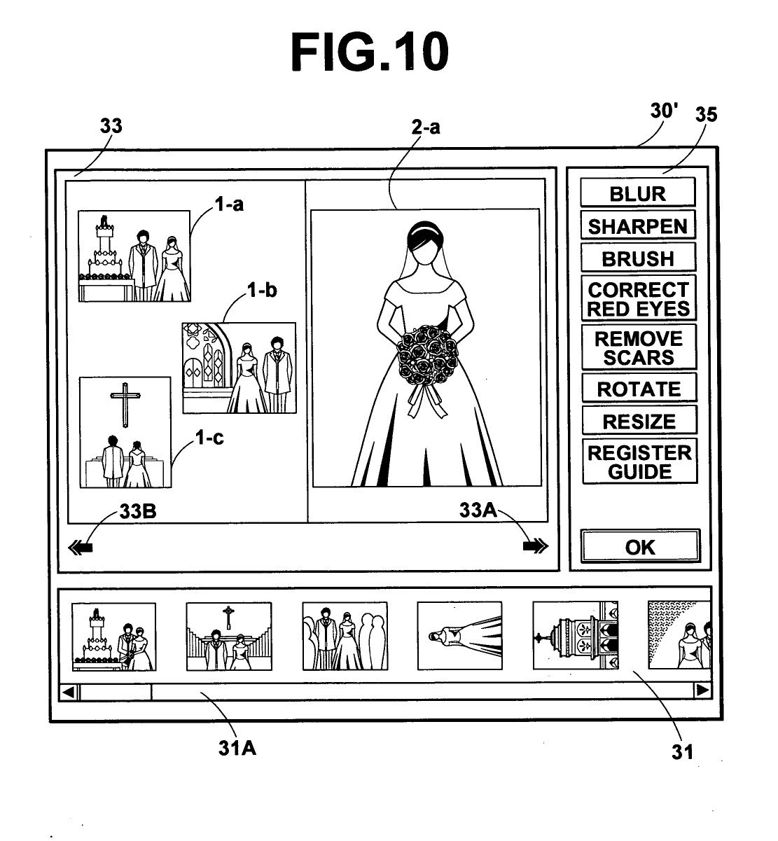

Then, the album editing PC 1 receives an edit instruction, input by the operator with reference to the editing screen 30 (step S16). In the second embodiment of the present invention, a guide register button for registering an image, inserted in an image insertion area, as a guide image is displayed in the tool box 35 of the editing screen 30′, as illustrated in FIG. 10. After step S16, the album editing PC 1 judges whether the operator has clicked the guide register button (step S17). If step S17 is YES, the album editing PC 1 sends the file name of image data, inserted in the image insertion area, to the file server 5 as guide image update information (step S18).

The file server 5 refers to the database DB1, and updates the file name of the guide image data, sent to the album editing PC 1, by using the file name of the image data, sent by the album editing PC 1 (step S19).

If step S17 is NO, or after step S18, the album editing PC 1 judges whether the DETERMINE button has been clicked (step S20). If step S20 is YES, the album editing PC 1 generates image edit information, and sends it to the file server 5 (step S21). If step S20 is NO, processing goes back to step S16. The album editing PC 1 continuously receives an edit instruction from the operator.

The file server 5 receives the image edit information, and performs image edit processing with reference to the file name of the selected image data, included in the image edit information (step S22). Then, the file server 5 outputs processed image data, generated by the image edit processing, and layout information, generated based on the image edit information, to one of the mini-laboratories 3A and 3B (step S23), and processing ends.

In the second embodiment, when the guide register button is clicked in step S17, the album editing PC 1 sends the guide image update information to the file server 5. Alternatively, when DETERMINE button is clicked in step S20, the album editing PC 1 may automatically send the file name of image data, selected to be inserted in the image insertion area, to the file server 5 as the guide image update information. In this case, in the processing illustrated in FIG. 8, the album editing PC 1 does not perform the judgment in step S17. After step S20, the album editing PC 1 judges whether an automatic transmission mode is set. If the automatic transmission mode is set, the album editing PC 1 sends the guide image update information to the file server 5. The file server 5 updates the file name of the guide image data based on the guide image update information.

In the second embodiment, the previous image is used as the guide image as described above. Alternatively, the file name of the image data, used a plurality of times in the past album production, may be correlated with the image insertion area of the template, and stored in the database DB2. When an image insertion area of the template is selected by clicking or like, a plurality of guide images, including a plurality of past images, which corresponds to the selected image insertion area, may be displayed on the editing screen. Hereinafter, display of a plurality of guide images is called a third embodiment. In the third embodiment, a guide image, sent with reference to the database DB2, is referred to as a history guide image.

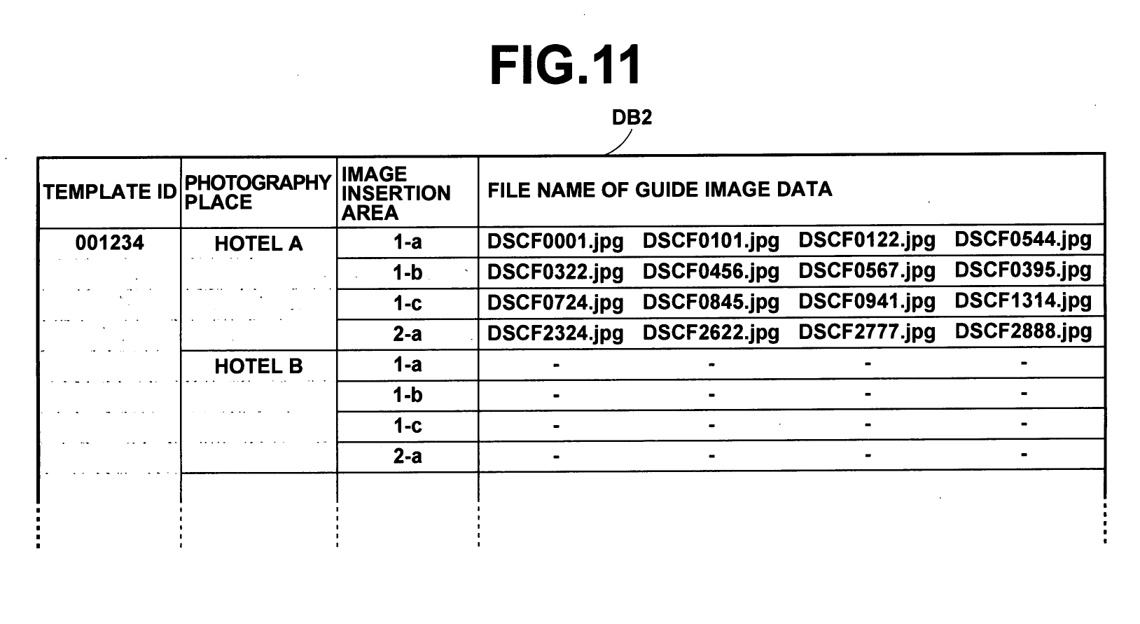

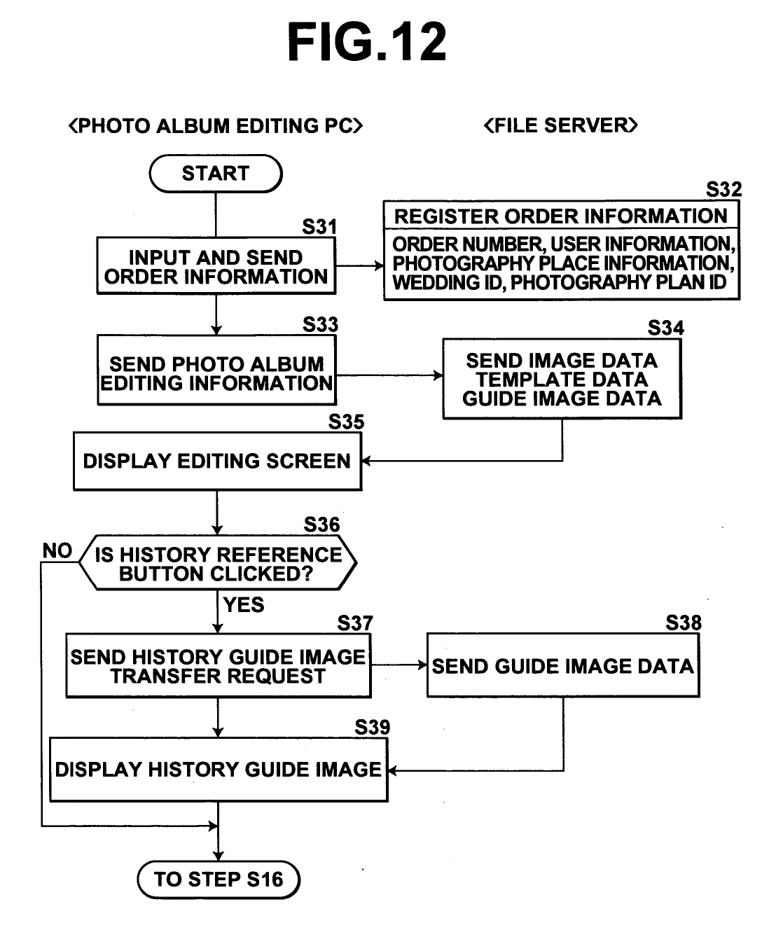

FIG. 12 is a flow chart illustrating processing performed in the third embodiment of the present invention. In the third embodiment, an album of the template, which will be used, has been produced by using photographs taken at various photograph places. It is assumed that the database DB2 is stored in the file server 5. In the database DB2, information (template ID) specifying a template, information representing a photography place of a used image, an image insertion area, and image data representing an image inserted in the image insertion area are correlated with each other, as illustrated in FIG. 11.

When the operator instructs album edit at the album editing PC 1, processing starts. First, the album editing PC 1 sends order information, input by the operator, to the file sever 5 (step S31) The file server 5 registers the order information (step S32). The album editing PC 1 also sends the album edit information to the file server 5 (step S33).

The file server 5 receives the album edit information, and sends image data, which is stored in a folder corresponding to a user ID, template data representing a template of the type specified by the user, and guide image data representing a guide image, which will be inserted in the image insertion area of the template, to the album editing PC 1 (step S34). Here, the sending guide image data is image data representing an illustration or illustrations representing the composition to be inserted in the image insertion areas, drawings, sample images obtained by photography of a model in an actual place or in an actual situation, or like, as described above in the first embodiment.

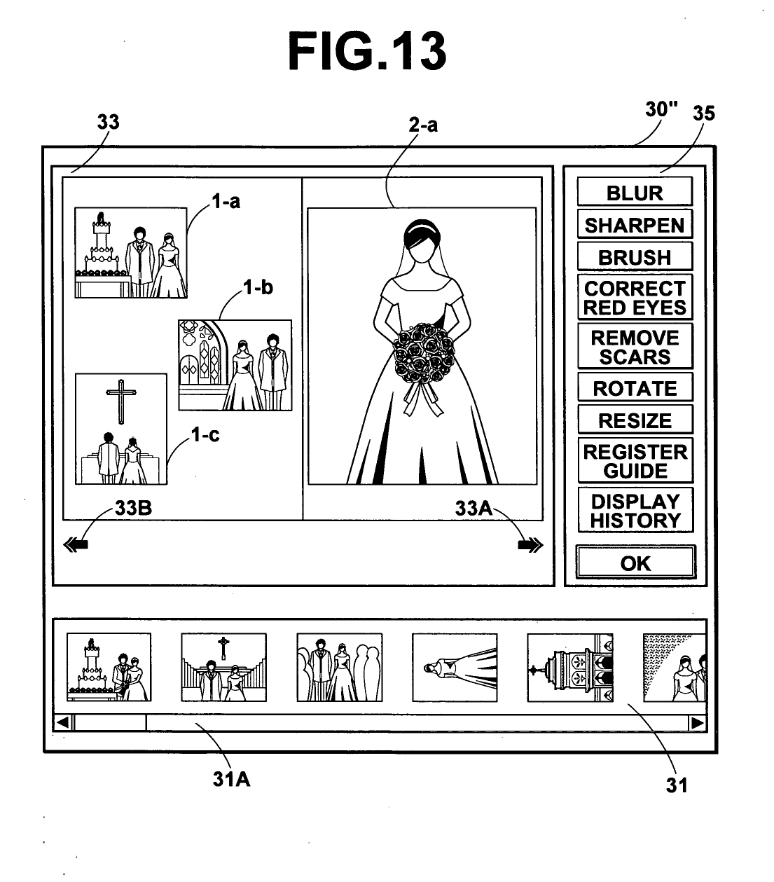

The album editing PC 1 receives the image data, the template data, and the guide image data, and displays an editing screen 30″ on the display means 15 (step S35). FIG. 13 is a diagram illustrating an initial screen of the editing screen in the third embodiment. As illustrated in FIG. 13, an image insertion area of a template is displayed in a template display field 33 of the editing screen 30″, and a guide image, represented by the guide image data, is inserted in the image insertion area. Further, a guide register button and a history reference button are displayed in the tool box 35.

The album editing PC 1 judges whether the operator has specified an image insertion area of the template, and clicked the hisotry reference button (step S36). If step S36 is YES, the album editing PC 1 sends a transfer request of the history guide image to the file server 5 (step S37).

The file server 5 refers to the database DB2, and sends the guide image data representing the history guide image to the album editing PC 1 (step S38).

In the third embodiment, the guide image data, sent from the file server 5 to the album editing PC 1, is image data representing a past image, which is obtained at the same photograph place as or a similar photograph place to the obtainment place of the image, which will be inserted in the image insertion area of the template of the type specified by the user, and which was selected to be actually inserted in the image insertion area of the same template. For example, if there is an order for album production by using a template with the template ID 001234, and the input photography place is hotel A, and the specified image insertion area is 2-a, the file server 5 sends image data with file names DSCF2324.jpg, DSCF2622.jpg, DSCF2777.jpg, and DSCF2888.jpg to the album editing PC 1 as the guide image data.

The album editing PC 1 generates a thumbnail image of the history guide image corresponding to the image insertion area, specified by the user, and displays the thumbnail image on the editing screen 30″ (step S39).

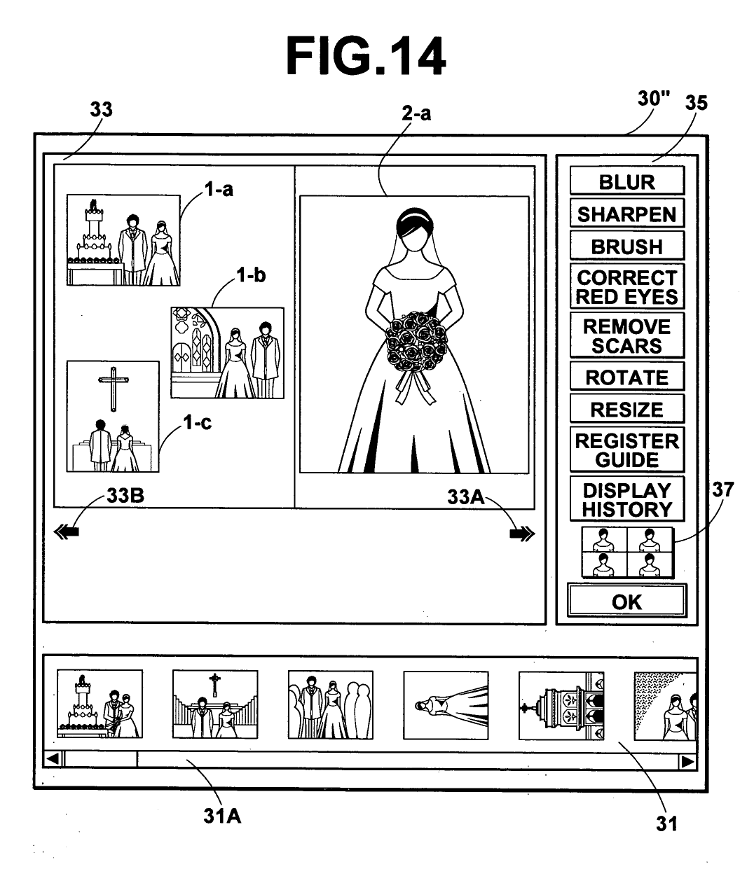

FIG. 14 is a diagram illustrating an editing screen, on which the thumbnail image of the history guide image is displayed. As illustrated in FIG. 14, a sample display field 37 for displaying the thumbnail image of the history guide image corresponding to the image insertion area (for example, 2-a), specified by the user, is displayed in the tool box 35 of the editing screen 30″. When the operator clicks a desired history guide image among four history guide images, displayed in the sample display field 37, the album editing PC 1 displays the history guide image in the image insertion area, specified by the operator. Accordingly, the operator can check whether the photo album has been produced successfully with reference to the actually used image.

The operator may refer to the history guide image corresponding to the specified image insertion area by specifying each of the image insertion areas and clicking the history display button, and insert the selected history guide image in the image insertion area.

After this, the edit operation is performed by performing the processing from step S16 in the second embodiment.

In the second and third embodiments as described above, actually used images are used as the guide images. Therefore, it is preferable that mosaic processing is performed on the part of the guide image, which represents a person, a part of the guide image is encrypted, or a character or sign is provided to indicate that the guide image is an actually used image to protect privacy.

In the embodiment described above, the processed image data sets of the selected images are printed by the mini-laboratory 3A or 3B, and the operator pastes the prints on the photo album paper corresponding to the template for generating the photo album. However, the file server 5 may generate a composite image data set representing an image (a photo album image) having the images selected by the operator and inserted in the image insertion areas in the template by combining the processed image data sets and the template data set. The composite image data set is output to the mini-laboratory 3A or 3B.

If the mini-laboratory 3A or 3B prints the composite image data set generated in this manner, the photo album can be generated by simply binding the print of the photo album image, without pasting the prints on the paper.

In the above-described embodiment, the photo album is generated by using the image data sets obtained by reading the images recorded on the developed film. However, a photo album can be generated by using image data sets obtained by a digital camera. In this case, the file server 5 comprises a media drive for reading the image data sets from a recording medium such as a memory card storing the image data sets obtained by photography. The image data sets read from the recording medium by the media drive are stored in the file server 5.

In the above-described embodiment, the file server 5 carries out the preparatory processing only on the image data sets selected by the operator using the photo album editing PC 1. However, all the image data sets may be stored in the file server 5 after the preparatory processing carried out thereon when the image data sets are received from the mini-laboratory 3A or 3B or from the scanner 3C. Furthermore, the photo album editing PC 1 may carry out the preparatory processing on all the image data sets sent from the file server 5 or on the image data sets selected for the photo album generation.

In the embodiments as described above, the photo album editing PC 1 or the file server 5 may generate, based on layout information, data (album data) including a user image inserted in a template, and the data may be sent to a server or like, which can be accessed by the user, and stored. Accordingly, the user can check whether the photo album will be successfully produced before actual production of the photo album. Further, in this case, the user may select whether the photo album is produced by using the album data or the photo album is reedited.

1. An image editing apparatus comprising:
display means for displaying various kinds of information;
image display control means for displaying a catalog of images on the display means;
template display control means for displaying on the display means a template used as photo album paper and having at least one image insertion area, together with the catalog of the images;
guide image display control means for displaying on the display means a guide image or guide images for guiding an image or images to be inserted correspondingly in the image insertion area or areas; and
image selection means for receiving selection of the image or images to be inserted in the corresponding image insertion area or areas from the catalog of the images.

2. The image editing apparatus according to claim 1, wherein the guide image display control means displays the guide image or images in the corresponding image insertion area or areas in the template displayed on the display means.

3. The image editing apparatus according to claim 1, wherein the guide image or images are an illustration or illustrations representing composition of the image or images to be inserted in the corresponding image insertion area or areas, or a drawing or drawings, or a sample image or sample images obtained by photography of a model in an actual place or in an actual situation.

4. The image editing apparatus according to claim 1, wherein the guide image is a past image, which has been actually inserted in each of the image insertion areas.

5. The image editing apparatus according to claim 1, wherein the guide image is a past image, which was obtained at the same photography place as or a similar photography place to the obtainment place of an image, which will be inserted in each of the image insertion areas, and which was selected to be actually inserted in each of the image insertion areas of the template.

6. The image editing apparatus according to claim 1, wherein if there is a plurality of guide images, the guide image display control means is a means for displaying the plurality of guide images so that a guide image can be selected from the plurality of guide images and displaying a single guide image, selected from the plurality of guide images, in each of the image insertion areas.

7. The image editing apparatus according to claim 1, wherein the template is a template for wedding.

8. The image editing apparatus according to claim 1, wherein information on the guide image or images to be inserted in the corresponding image insertion area or areas is described in a header of template data representing the template.

9. The image editing apparatus according to claim 1, wherein, in response to selection of the image insertion area or any one of the image insertion areas, the guide image display control means displays the guide image corresponding to the image insertion area outside the image insertion area.

10. The image editing apparatus according to claim 1 further comprising editing means for editing the image or images inserted in the image insertion area or areas.

11. The image editing apparatus according to claim 10, wherein the editing means carries out at least one of processing for changing a quality of the image or images, processing for re-shaping the image or images, and processing for restoring the image or images on the image or images.

12. An image editing method comprising the steps of:
displaying a catalog of images on display means;
displaying on the display means a template used as photo album paper and having at least one image insertion area, together with the catalog of the images;
displaying on the display means a guide image or guide images for guiding an image or images to be inserted correspondingly in the image insertion area or areas; and
receiving selection of the image or images to be inserted in the image insertion area or areas from the catalog of the images.

13. A program for causing a computer to execute an image editing method comprising the steps of:
displaying a catalog of images on display means;
displaying on the display means a template used as photo album paper and having at least one image insertion area, together with the catalog of the images;
displaying on the display means a guide image or guide images for guiding an image or images to be inserted correspondingly in the image insertion area or areas; and
receiving selection of the image or images to be inserted in the image insertion area or areas from the catalog of the images.
